(19) United States
(12) Patent Application Publication
(10) Pub. No.: US 2019/0095995 A1
(43) Pub. Date: Mar. 28, 2019

(54) SYSTEMS AND METHODS FOR OPERATING EXCHANGE CONTROLLED NETWORK HANDLING DIGITIZED ASSET BACKED MEDIUMS OF EXCHANGE

(71) Applicant: DEARBORN FINANCIAL, INC., St. Charles, IL (US)

(72) Inventor: Michael B. ROHLFS, Northbrook, IL (US)

(73) Assignee: DEARBORN FINANCIAL, INC., St. Charles, IL (US)

(21) Appl. No.: 16/205,511

(22) Filed: Nov. 30, 2018

Related U.S. Application Data
(60) Provisional application No. 62/598,172, filed on Dec. 13, 2017.

(51) Int. Cl. G06Q 40/04; G06Q 20/06; G06Q 20/38

(52) U.S. Cl. CPC G06Q 40/04; G06Q 20/065; G06Q 2220/00; G06Q 20/3829; G06Q 20/3825; G06Q 20/389

(57) ABSTRACT

A computerized Exchange-controlled network (“ECN) based system that facilitates trading of one or more digitized (i.e., securitized and tokenized) asset-backed mediums of exchange (“DABMoE”), including one or more cryptocurrency tokens, is disclosed which is operated by an Exchange acting in cooperation with (i) Exchange Affiliates providing price discovery of various tradable assets by matching the bilateral interests of wholesale counterparties having practically, rather than absolute, opposite trading interests predicated on physical delivery and receipt of said assets and (ii) external cryptocurrency exchange organizations (“ECCEO”) registering and servicing retail user-customers while providing wallet and payment facilitation applications to prevent incidences of double spending and reversals.

### CROSS-REFERENCE TO RELATED APPLICATIONS

This application claims the benefit of U.S. Provisional Application No. 62/598,172, filed on Dec. 13, 2017. The entire disclosure of the application referenced above is incorporated herein by reference.

### FIELD

The present disclosure relates to systems and methods for digitized (i.e., securitized and tokenized) asset-backed mediums of exchange (“DABMoE”), and more particularly to systems and methods for operating a cryptographically assured exchange-controlled network (“ECN”) handling the formulation, trading and usage of one or more DABMoE and their underlying tradable assets.

### BACKGROUND

The statements in this section merely provide background information related to the present disclosure and may not constitute prior art.

U.S. Pat. No. 9,460,470, assigned to the assignee of the present application, discloses and claims subject matter tied to countertrade and barter platforms employing novel systems, methods and instruments that practically (rather than absolutely) match the authenticated bilateral interests of initiating exchange-traded derivative (“ETD”) platforms' physical delivery minded counterparties. Such platforms inter alia execute and settle equivalent-for-equivalent trades via uniform processes employing price references predicated on suitable globally recognized financial mediums selected to minimize or eliminate the conventional practice of merely tendering national currencies when an ETD's underlying tradable assets are physically delivered and received as of the attendant platform's or platforms' operative contract settlement date or dates. They are part of the assignee's set of solutions addressing the impact of digital transformation disrupting physical asset markets as traders and risk managers are becoming increasingly exposed to (i) technologies and networks converging to dematerialize supply chain and lifecycle management processes; and (ii) previously independent systems interoperating to unlock automation expected to produce unprecedented cost savings and new business opportunities.

To that end, innovative market infrastructures must emerge to more transparently connect physical economies and the financial sector. The assignee's solutions—which involve uniform systems, methods and instruments formulated for the global execution and physical settlement of large volumes of standardized-yet-customizable asset trades over an integrated family of affiliated cloud-powered computerized trading exchange platforms, collectively referred to as Trading Exchange Platforms (TEPS)—have been innovated to serve as a catalyst for such transparent connectivity and to benefit the investment field at large by increasing prospects for greater physical asset trading, hedging and digitization liquidity while reducing attendant transaction costs via the synergy created by this invention's integration (and resultant ability to interoperate) with TEPS' various ETD platforms disclosed and claimed in U.S. Pat. No. 9,460,470.

### SUMMARY

A cryptographically-assured exchange-controlled network (“ECN”) is configured to formulate, securitize and issue, and to facilitate and validate buying and selling of, digitized asset-backed mediums of exchange (“DABMoE”) designed to minimize or eliminate use of established national currencies in connection with commercial and financial transactions while unlocking value of underlying tradable assets that may otherwise be illiquid or under-utilized. The ECN is controlled by an Exchange organization that matches its counterparties' practically, rather than absolute, opposite trading interests predicated on physical delivery and receipt of a diverse range of commodities, credit instruments and other tradable assets having varying quality and logistics properties falling within parameters specified in physically settleable derivatives contracts formulated, traded, executed and settled over one or more Exchange Affiliates' computerized trading platforms. The tradable assets qualifying as part of benchmark sets are physically segregated and securitized into unitary ownership interests encompassing one or more Exchange-formulated weighted average DABMoE Baskets.

The ECN comprises at least one processor configured to execute a plurality of machine executable instructions and at least one memory in communication with the processor. The memory is configured to store the machine executable instructions which when executed by the processor are configured to collect data for a plurality of underlying tradable assets that are acquired, segregated, inventoried and controlled by the Exchange on behalf of owners of DABMoE Basket unitary interests. The data include at least one parameter relating to a physical property or quality of the tradable assets. The instructions are further configured to select assets from the tradable assets based on either the at least one parameter, or physical property or quality, of the assets, to generate sets of tradable assets underlying attendant weighted-average DABMoE Basket unitary ownership interests.

The instructions are further configured to generate weights for generating weighted averages, where a weight for generating a weighted average for sets of underlying tradable assets contained in a weighted-average DABMoE Basket is based on at least an Exchange-specified rate denoting estimated global commercial significance of a selected tradable asset relative to aggregate estimated global commercial significance of all tradable assets underlying attendant weighted-average DABMoE Basket unitary interests formulated by the Exchange for customer ownership, use and trading. The instructions are further configured to generate tradable asset baskets based on aggregate weighted averages of properties of the selected tradable assets in a basket.

The instructions are further configured to communicate weighted average DABMoE Basket of tradable assets, and related unitary interests formulated by the Exchange for their ownership and trading, to customers and receive orders for such unitary interests from authenticated traders of the Exchange and other parties entitled to buy or sell such unitary interests.

The instructions are further configured to operate with the data collection, selection, weight generating, basket generating, communication and order processing modules as a DABMoE conversion module (“DCM”) that subdivides the weighted-average DABMoE Basket into Exchange-authorized quantities of: unitary ownership interests formulated for offerings to wholesale user-customers of the Exchange; and cryptocurrency tokens formulated for offerings to external cryptocurrency exchange organizations (“ECCEO”) that register and service retail user-customers who want to buy, hold and sell said cryptocurrency tokens, while also providing said customers with wallet and payment facilitation applications unique to centralized networks that prevent incidences of fraud, such as manipulated or falsified transactions, as well as double-spending and reversals.

The orders of weighted-average DABMoE Basket unitary ownership interests offered to wholesale user-customers of the Exchange, plus orders of weighted-average DABMoE Basket-based cryptocurrency tokens offered to ECCEO, are effectuated by a back-to-back execution module that is processed by an application stored in the memory and executed by the processor. The application is employed to take into consideration the gross segregated tradable asset inventories on hand for each type of asset, a portion of such inventories to be held in reserve to optimize an efficiency of the Exchange organization in matching its counterparties' physically settled derivatives orders over a projected future time frame, and an ability to substitute different varying-yet-fungible and cyclable tradable asset forms within respective net tradable asset set parameters specified by the Exchange as part of its formulation and maintenance of a weighted average DABMoE Basket.

In other features, the tradable assets comprise at least one of the following types: energy commodities in a form of crude oil, refined products derived from crude oil, natural gas and coal; industrial minerals and rocks (IMRs), and fertilizers derived therefrom; any other commodity produced globally and having varying quality and logistics properties or attributes that impact a market place value of the asset; any credit or other financial instrument having varying quality and logistics properties or attributes that impact a market place value of the instrument; any national currency; and any other tradable asset that is exchangeable according to terms of a barter or countertrade transaction executable over an Exchange Affiliate's barter or countertrade platform.

In other features, the tradable assets segregated, inventoried and controlled by the Exchange are acquired from Exchange members including but not limited to asset producers, trading companies, financial institutions and investors, with such acquisitions transacted either via cash payments made by the Exchange, issuance of one or more Exchange memberships or issuance of weighted-average DABMoE Basket unitary ownership interests.

In other features, the collected data is updated periodically; the weighted-average DABMoE Basket is updated based on the collected updated data; and the weighted-average DABMoE Basket is communicated to the ECN's defined communities of interest (“COI”).

In other features, the ECN comprises a server in communication with a computing device used by the ECN's defined COI via at least one of a wide area network or the Internet.

In other features, the weighted-average DABMoE Basket unitary ownership interest registrants, the ECCEO and its registrants are provided customized hardware and/or software dongles for their respective servers, with each having a unique authorization code serving to: control access to the ECN, what data is made available to each host and front-end server connected over the ECN, where data is stored and who manages various storage needs within the ECN's defined COI; enable buy and sell orders of weighted-average DABMoE unitary ownership interests and ECCEO cryptocurrency tokens to be cryptographically authenticated, posted, and ultimately matched, executed and cleared as valid trades to be settled and reported over the ECN in accordance with policies and rules established by the Exchange; and accomplish the controlling and the enabling, contemporaneously, without the need for intermediaries to be used in the chain of communications, all the while facilitating creation and maintenance of customized permissioned ledgers shared by impacted COI in the process.

In other features, the back-to-back execution module is operative with the DCM to consolidate all customer bids and offers for ultimate execution at the Exchange pursuant to a cross-liquidity process factoring prevailing relative order flow of each Exchange trading platform and each ECCEO, and triggers, when necessary, back-to-back executions such that: the Exchange becomes a counterparty to its primary customer's weighted-average DABMoE Basket unitary ownership interest bid or offer; and the Exchange then simultaneously posts an offsetting offer or bid, which upon DCM processing is converted to a component of either a weighted-average DABMoE Basket unitary ownership interest or cryptocurrency token earmarked for retail syndication via one or more ECCEO.

In other features, the processor uses the application to compute requisite number of weighted-average DABMoE Basket unitary ownership interests and cryptocurrency tokens, respectively, authorized for issuance by the Exchange and operates in cooperation with a Serialization Module to assign Exchange-authorized serial numbers to each unit and token, respectively and without any rights of interchangeability, as well as to any applicable sub-serial numbers attendant to fractional interests connected thereto.

In other features, each Serialization Module-assigned serial number and sub-serial number digitally reflects cryptographic histories of all key functions having occurred over the ECN in connection with attendant inventory control and DABMoE formation, securitization, issuance and originating valuation processes, all incorporated into a Digital Identification Scheme enabling the Exchange to confirm validity, via unique encrypted origination and history data, of all weighted-average DABMoE Basket unitary ownership interests and cryptocurrency tokens placed into and removed from circulation since inception to guard against threats of manipulated or falsified transactions perpetrated in the field and, when combined with attendant cryptographic signature or key creates an immutable and traceable ledger entry accessible by authorized COI over the ECN.

In other features, the Exchange is the only entity authorized to issue weighted-average DABMoE Basket unitary ownership interests and crypto-currency tokens, respectively, and to assign their attendant serial numbers and sub-serial numbers, and does not recognize interchangeability or ownership claims of any units, tokens, serial numbers or sub-serial numbers alleged to have been created by unauthorized token miners or other parties practicing similar computer processes common to decentralized cryptocurrency schemes such as Bitcoin or other alternative cryptocurrencies in the field.

In other features, the Exchange employs inventory management and control systems attendant to the computation of qualifying gross and net segregated tradable assets available for securitization and tokenization, with such systems employing at least private and public warehouse receipts and shipping certificates that can be reconciled with all issued and outstanding weighted-average DABMoE Basket unitary ownership interests and cryptocurrency tokens in the field.

In other features, the Exchange-authorized COI includes at least one of: ECCEO that register and service retail user-customers for token trading while also providing those customers with Exchange-authorized wallet and payment facilitation applications; wholesale commercial and speculator customers of the Exchange; introducing brokers; non-clearing commercial merchants; clearing members of the Exchange or its Exchange Affiliates; non-clearing members of the Exchange or its Exchange Affiliates; one or more Exchange-authorized tradable asset inventory control and logistics service providers; one or more Exchange-authorized tradable asset securitization service providers; one or more clearinghouses either affiliated with the Exchange or independently contracted; one or more trade reporting service firms; and one or more independent regulatory bodies charged with oversight responsibility in connection with the conduct of the Exchange's trading markets.

In other features, a hybrid paradigm is formed to digitize benchmark-qualified assets, the digitizing including securitizing and tokenizing, that are varying-yet fungible and thus cyclable in and out of baskets comprising the benchmark-qualified assets, all transparently price-discoverable, financeable and hedgeable via an integrated suite of affiliated computerized trading exchange platforms globally organized around a common cloud-based exchange-controlled network.

In other features, the Exchange authorizes the ECCEO's to resell Exchange-issued retail DABMoE cryptocurrency tokens to user-customers without forcing said customers to become authenticated members of the ECN, subject to the following caveats that, if not followed, serve to invalidate the tokens: unauthenticated user-customers and cryptocurrency exchanges they subsequently trade with do not alter assigned identification numbers (“IDN”), cloaking systems and methods, and other cryptographic codes attendant to a serialization scheme of the Exchange; no mining or other similar validation activities typically performed in connection with other cryptocurrencies are authorized by the Exchange and, as such, preclude the issuance of any valid newly-issued retail DABMoE cryptocurrency token(s); all tracking and tracing histories subsequent to initial issuance of the attendant token(s) by the Exchange are responsibilities of the unauthenticated user-customers and cryptocurrency exchanges; and any future Exchange-authorized redemption of retail DABMoE Cryptocurrency tokens in valid circulation held by unauthenticated user-customers or cryptocurrency exchanges is effectuated by an Exchange-authenticated ECCEO.

In still other features, a system provides a hybrid paradigm for optimizing connectivity between physical asset markets and financial sector. The hybrid paradigm comprises digitizing fungible assets possessing varying qualitative and logistics attributes, where digitizing includes securitizing and tokenizing, where each asset gains liquidity from synergy created by transparent price-discovery, repurchase agreement (“repo”) based financing, exchange-traded derivatives (“ETD”) based value hedging, and inventory management and control processes prescribed by Benchmark Complex Solutions (“BCS”) developed to match counterparties whose trading interests are practically, rather than absolutely, opposite so that larger volumes of trade orders are more efficiently executed and settled by physical delivery and receipt over computerized trading platforms integrating an affiliated set of Exchanges, their customers and respective communities of interest via cloud-powered, cryptography-assured and dongle-enabled ECN's and permissioned ledgers.

In other features, the BCS are comprised of one or more Exchange Affiliates: configuring weighted average benchmark (“WAB”) sets, with each set linked to an Exchange-specified plurality of qualifying asset forms, rather than arbitrarily denoting one single asset form as the benchmark for all forms of that asset; and identifying and factoring impact of qualitative and quantitative properties unique to the asset forms serving as a basis of a neutral WAB formulated by the Exchange for an entirety of the set. The one or more Exchange Affiliates further provide a uniform method of allowances for incidences where traders physically own or are seeking to own varying yet interchangeable asset forms, each qualified as a component of an Exchange-specified set, to offer or bid their specific asset form pursuant to standardized spot or forward EFP contracts calling for settlement by physical delivery or receipt of their respective underlying assets, with each contract's specifications linked to an operative WAB formulated by the Exchange to cover an entire set of qualified asset forms.

The one or more Exchange Affiliates further ensure that each component in a WAB provides quantitative characteristics, plus varying qualitative and logistics properties customarily adding to or detracting from such asset's market value, net effects of which are balanced Exchange-wide by methods integral to establishing benchmark-specific WAB sets, each formulated for incorporation into a family of standardized exchange-traded derivatives (“ETD”) contracts, the ETD contracts including spots, forwards, futures, options and spreads, specifications of which differ only by timing and type of settlement taking place.

The methods are further integral to requiring EFP spot and forward traders to acquire a specific number of long or short Complementary Differential Index contracts linked to varying qualitative attributes of underlying assets respectively delivered or received, and to ensure co-delivery of such contracts as of an operative EFP physical delivery date. The methods are further integral to requiring EFP spot and forward traders to acquire a specific number of long or short Forward Point Delivery Differential Index contracts linked to a negotiated timing of underlying assets respectively delivered or received, and to ensure co-delivery of such contracts as of an operative EFP physical delivery date.

The methods are further integral to uniformly employing the methods to formulate, maintain and hedge future price volatility risks of wholesale and retail DABMoE on a practically equivalent basis, achieved by instilling parameters for cycled interchange of varying-yet-fungible assets qualified within Exchange-specified baskets underpinning DABMoE, said parameters serving to account for qualitative, logistical, supply chain and life cycle factors unique to assets held and securitized by Exchange(s) prior to their delivery to counterparties, as well as assets held in reserve by Exchange(s) to ensure their ongoing role as ETD liquidity provider(s), with the parameters incorporated as part of proprietary float processes employed within the confines of an affiliated Exchange-wide inventory management and control system.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The drawings described herein are for illustration purposes only and are not intended to limit the scope of the present disclosure in any way.

FIG. 1 is a block diagram illustrating one embodiment of the present disclosure: an ECN for baskets of tradable assets securitized and tokenized, respectively, in the form of: (i) weighted average DABMoE unitary ownership interests earmarked for buying, selling and use by wholesale DABMoE Exchange customers and customers of ETD exchanges affiliated with the DABMoE Exchange (“Exchange Affiliates”) and (ii) tandem weighted average DABMoE cryptocurrency tokens earmarked for authorized retail user-customers of external cryptocurrency exchange organizations (“ECCEO”) and their related wallets and payment facilitation applications;

FIG. 2 is a chart illustrating differences between existing Bitcoin and Altcoins and the DABMoE of the present disclosure;

FIG. 3 is a flowchart illustrating operations that may be performed by the DABMoE Exchange (also referred to herein either as the “Exchange”), Exchange Affiliates and users of DABMoE within the confines of the ECN cited in FIG. 1; and

FIG. 4 shows a Chart Legend to illustrate one example of how each Exchange-specified communities of interest (“COI”) member's authentication ID number is assigned for use within the ECN system (or not, in which case cloaking takes place), the type of Exchange and/or Clearinghouse data communications sent to each COI member, and each COI member's data communications type of reply to the Exchange and/or Clearinghouse, as well as to other COI members authorized to see and, where necessary, accept such reply.

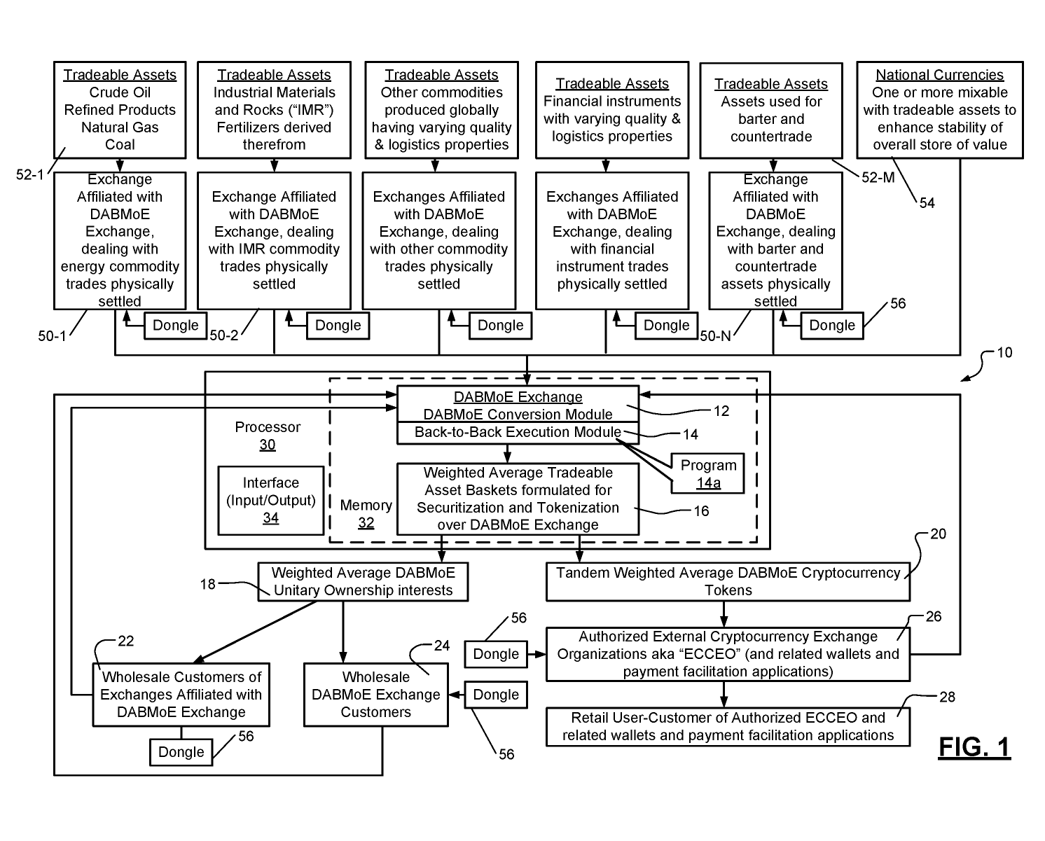

Augmenting FIGS. 1 through 4, FIG. 5 is a flowchart presenting a general overview of the flow of qualifying tradable assets specified within the confines of TEPS' various physically settleable ETD platforms and DABMoE Exchange; and the role played by this invention's novel system of managing and controlling the flows of globally diverse ranges of uniquely specified sets of fungible assets impacted by their varying qualitative and logistics specifications, accomplished by employing methods that optimize inventory float integral to maintaining liquidity throughout TEPS's ETD platforms, as well as consistency (on a practically equivalent basis) of those qualifying sets of physical assets underlying each securitized and tokenized unit, basket and DABMoE integral to the DABMoE Exchange.

### DETAILED DESCRIPTION

The following description is merely exemplary in nature and is not intended to limit the present disclosure, application, or uses. It should be understood that throughout the drawings, corresponding reference numerals indicate like or corresponding aspects and features.

The present disclosure relates to DABMoE systems, methods and instruments, with the latter posited for potential mass appeal as a more commercially substantive global cryptocurrency alternative versus Bitcoin and other decentralized altcoins lacking any underlying tangible asset value.

The present invention relates to a multi-faceted ECN configured to overcome complex technical challenges when creating weighted average tradable asset baskets comprised of the types of diversified sets of globally significant assets (i.e., not mere derivatives) qualifying for physical deliveries and receipts pursuant to ETD settlements typically taking place over the aforementioned platforms, where each weighted average tradable asset basket is formulated for global suitability and value stability, then securitized and tokenized into DABMoE that are more substantive than Bitcoin and altcoins known to populate the cryptocurrency field. The intent is for DABMoE to be used globally by wholesale and retail customers desiring a trustworthy cryptocurrency network that can deliver authenticity, efficiency, security and privacy, as well as (in the particular case of retail customers) interoperability with external cryptocurrency exchange organizations (“ECCEO”).

The present invention involves a computerized ECN system 10, as indicated in FIG. 1, that facilitates trading of one or more DABMoE, including one or more cryptocurrency tokens. The ECN system 10 is operated by an entity, referred to herein as the DABMoE Exchange or simply as the “Exchange”, acting in cooperation with (i) Exchange Affiliates 50-1, 50-2, . . . , 50-N (collectively Exchange Affiliates 50) that may be prime sources of, and providers of valuable price discovery and optimized liquidity for, various tradable assets 52-1, 52-2, . . . , 52-M (collectively tradable assets 52)—with each asset type set being a candidate for inclusion in weighted average tradable asset baskets 16 formulated for securitization and tokenization over the Exchange—since Exchange Affiliates 50 are designed to uniquely match the bilateral interests of counterparties having practically, rather than absolute, opposite trading interests predicated on physical delivery and receipt of said assets, (ii) wholesale customers 22 and 24 wanting to buy, sell and use Weighted Average DABMoE Unitary Ownership Interests 18 as part of their trade settlements taking place over the Exchange or its Exchange Affiliates' platforms, and (iii) ECCEO 26 registering and servicing retail user-customers 28 while providing wallet and payment facilitation applications to inter alia prevent incidences of double spending and reversals in connection with the Exchange's tandem Weighted Average DABMoE Cryptocurrency Tokens 20. A DABMoE Conversion Module (“DCM”) 12 is employed to generate weighted average baskets 16 of Exchange-specified tradable assets underlying wholesale DABMoE unitary beneficial ownership interests 18 and tandem retail cryptocurrency tokens 20. A back-to-back execution module 14 is processed by an application or a program 14a stored in a memory and running in the DCM 12.

A processor 30 may be used to run the DABMoE conversion module 12, the back-to-back execution module 14, and to execute the process 14a, as well as to communicate with the weighted tradeable asset baskets 16. Components 12, 14, 14a and 16 are illustrated in FIG. 1 as part of a memory 32 associated with the processor 30 and an interface 34, although it will be appreciated that each of components 12, 14 and 16 could be associated with fully separate memories and fully separate processors as well. Possibly, components 12, 14, 14a, 16, 30, 32 and 34 could be implemented on one or more servers. Processors, memories, and servers referenced throughout the application are tangible hardware computing devices capable of storing and executing instructions, also called applications or programs. For example, the servers include computers comprising one or more processors and one or more types of memories (e.g., RAM, hard disk drives, etc.).

The program 14a determines the extent to which any national currencies 54 should be mixed with a diverse range of tradable assets 52 to arrive at a stable overall store of value underlying DABMoE. In factoring the diverse range of tradable assets 52, the program 14a computes: (i) gross segregated tradable asset inventories acquired, or acquirable, in the course of Exchange Affiliates' ETD platform operations, which are thus eligible for inclusion into each set of asset type securitized and then contained in a weighted average basket 16; (ii) a portion of gross segregated tradable asset inventories which need to be kept in reserve to optimize each Exchange Affiliate's price discovery efficiency in matching its counterparties' physically-settled ETD orders over a projected future time frame; (iii) net segregated inventories available for the weighted average basket, which is arrived at by subtracting (ii) from (i); (iv) fungibility allowances to enable practical substitution of qualitatively similar-yet-varying tradable asset forms within the same set of tradable asset forms specified by an Exchange Affiliate as part of the DABMoE Exchange's weighted average basket 16; and (v) the extent to which one or more national currencies 54 may need to be added to the mix to insure overall store value stability over time.

The back-to-back execution module 14 facilitates transfers of the requisite (program determined) underlying tradable assets from Exchange Affiliates to the DABMoE Exchange and then assigns serial numbers to wholesale DABMoE Basket unitary beneficial ownership interests 18 and tandem retail cryptocurrency tokens issued 20, respectively, plus any sub-serial numbers attendant to any fractional interests connected therewith.

The ECN system 10 provides the DABMoE Exchange with at least one host server disposed at a first location which communicates with at least two front-end virtual servers disposed at second and third locations, wherein the servers are attendant to Exchange-authorized COI, each made up of at least one COI member authenticated to cryptographically validate and process digital information passed along the ECN system 10. A plurality of devices in the form of hardware and/or software dongles 56, as described in U.S. Pat. No. 9,460,470, are each configured to operate in conjunction with COI members' servers, enabling the ECN system 10 to exercise controls over all aspects of digital data access, storage, order processing and execution, as well as digital trade clearance, settlement and reporting without the use of intermediaries in the chain of communications.

A key aspect of the present invention is the ability for the Exchange to acquire the requisite tradable assets 52 from its Exchange Affiliate platforms in order to construct an aforementioned basket of specified assets as the foundation underlying a DABMoE. The back-to-back execution module 14 of this invention is operative between the Exchange and the initiating ETD platforms employed by various Exchange Affiliates 50, including the affiliated barter or countertrade platform, all of which employ similarly developed information technology systems and methods and ETD instruments and contracts, such as spots, forwards and futures linked to tradable asset benchmark sets, and related complementary differential and forward point delivery differential index contracts. The concept of back-to-back execution module is also disclosed and claimed in co-owned published patent application US 2015/02221032 which deals with a Sharia-based hedging system and method, and which is hereby incorporated by reference.

Employing the back-to-back execution module 14 to facilitate a DABMoE Exchange operating in cooperation with one or more external cryptocurrency exchanges in the field is another important aspect of the present invention. In those instances, a back-to-back execution module is operative with the DCM to consolidate all customer bids and offers for ultimate execution at the Exchange pursuant to a cross liquidity process factoring the prevailing relative order flow of each Exchange trading platform and each ECCEO, and triggers, when necessary, back-to-back executions whereby the Exchange becomes a counterparty to its primary customer's weighted-average DABMoE Basket cryptocurrency token bid or offer; and the Exchange then simultaneously posts an offsetting offer or bid, which upon DCM processing is converted to a component of Weighted-Average DABMoE Basket cryptocurrency token earmarked for retail syndication via one or more ECCEO. A processor uses an application to compute requisite number of retail cryptocurrency tokens authorized for issuance by the Exchange and operates in cooperation with a Serialization Module to assign Exchange-authorized serial numbers to each retail cryptocurrency token, as well as any applicable sub-serial numbers attendant to fractional interests connected thereto.

Furthermore, each Serialization Module-assigned serial number and sub-serial number digitally reflects the cryptographic histories of all key functions having occurred over the ECN in connection with attendant inventory control and DABMoE formation, securitization, issuance and origination valuation processes, all incorporated into a Digital Identification Scheme enabling the Exchange to confirm validity, via unique encrypted origin and history data, of all retail Weighted-Average DABMoE Basket cryptocurrency tokens placed into and removed from circulation since inception to guard against threats of manipulated or falsified transactions perpetrated in the field and, when combined with attendant cryptographic signature or key creates an immutable and traceable ledger entry accessible by authorized COI over the ECN. The Exchange is the only entity authorized to issue retail Weighted-Average DABMoE cryptocurrency tokens and to assign their attendant serial numbers and sub-serial numbers, and does not recognize the interchangeability of ownership claims of any units, tokens, serial numbers or sub-serial numbers alleged to have been created by unauthorized token miners or other parties practicing similar computer processes common to decentralized cryptocurrency schemes such as Bitcoin or other alternative cryptocurrencies in the field.

Published co-owned patent application US 2017/0061540, the teachings of which are hereby incorporated by reference into the present disclosure, cites a computerized ECN with at least one host server in communication with at least two front-end servers, whereby all such servers are attendant to Exchange-authorized COI authenticated to cryptographically receive, validate, process, store and transmit digital information passed along the ECN without the use of intermediaries. Furthermore, a plurality of devices in the form of dongles are each configured to operate in conjunction with their respective COI member's server, and enable the Exchange to exercise controls over virtually all aspects of digital data access, storage and order processing, as well as related trade execution, clearing and settlement without the use of intermediaries in the chain of communications. The present invention may make use of some or all of these teachings.

Cryptocurrency Field

Cryptocurrencies (aka “altcoins”) currently in the field are digital assets designed to work as a medium of exchange using cryptography to secure transactions and control the creation of additional units of the currency. Bitcoin, created circa 2009, became the first fully implemented decentralized cryptocurrency. Subsequently, hundreds (if not thousands) of altcoins have been created. Their common thread is: decentralized control—derived from the use of bitcoin's blockchain transaction database technology facilitating the role of a distributed ledger—as opposed to centralized electronic money or banking systems.

Cryptocurrency systems typically maintain their safety, integrity and balance of ledgers by employing a community of mutually distrustful parties known as “miners”: members of the general public that use their own computers to solve complex math puzzles to help validate/verify cryptocurrency transactions added to the attendant ledger in accordance with a particular timestamping scheme.

The principal advantages of cryptocurrencies, as currently configured in the field, are as follows:

User Privacy: unlike in the case of debit cards, no personal information is required to transact, which is particularly appealing to criminals and money-launderers, as discussed more below;

Fast: immediate settlement unlike personal checks that may take several days to settle;

Inexpensive: transaction costs are 0-1% because there is no governmental monitoring or regulation; in contrast, credit card fees are typically 2.5% or higher; and

Global: no user accounts need to be domiciled in a specific country.

Disadvantages of existing cryptocurrencies are numerous. Initially, since the market is in a nascent stage, many commercial buyers and sellers, and investors, do not fully understand cryptocurrency risks; more particularly, they are not adequately aware of what causes price volatility risks tied to supply and demand uncertainties—e.g. those stemming from fluctuations in the relative usage by money-launderers and would-be evaders of capital controls or changes to the number of computers (and their respective “computer power”) set up to “mine” coins.

A major difficulty with Bitcoin and other altcoins has been their production, which until now was unregulated and not transparent to the world. However, that may be changing because recently the U.S. Securities Exchange Commission (“SEC”) indicated that “offers and sales of digital assets by ‘virtual’ organizations are subject to the requirements of the Federal securities laws” in particular as it relates to initial coin offerings and token sales.

Another drawback with Bitcoins and altcoins is that there is nothing to prevent coins being dumped by their creator(s) as part of a major cash-in.

Still another drawback is that cryptocurrency values are typically price-referenced in national currency values (mainly the US$ but also euro, yen, yuan), the market (or exchange rate) of which can change.

Still another drawback is the future impact of government regulations and/or technological developments that may someday reduce (even eliminate) user privacy and anonymity.

Perhaps most fundamentally, in the most critical light, bitcoins and altcoins have no intrinsic tangible value; their appeal is tied to users' perceptions re: how amazing the technology is, how the combination of cryptography and pseudoanonymity is so great, and how powerful they may become as social networking platforms.

Due to the forgoing, many merchants currently accepting bitcoin and other altcoins tend to promptly offload them for dollars (or other national currencies) at a cryptocurrency exchange for a fee.

Cryptocurrency Industry Sectors

The following are descriptions of the primary functions comprising the cryptocurrency industry, extracted from Global Cryptocurrency Benchmarking Study published earlier this year by the Cambridge Centre for Alternative Finance:

Cryptocurrency Exchanges provide services to buy and sell cryptocurrencies and other digital assets in exchange for national currencies and other cryptocurrencies. They play an essential role in the cryptocurrency economy by offering a marketplace for trading, liquidity, and price discovery. The exchange industry sector employs more people than any other cryptocurrency sector.

Wallets are software programs used to securely store, send and receive cryptocurrencies through the management of private and public cryptographic keys. They also provide user interfaces to track the balance of cryptocurrency holdings and automate other functions, e.g., estimating what fee to pay to achieve a desired transaction confirmation time.

Payment facilitators provide integrated payment networks to process transactions denominated in the native token. It should be noted that although users can independently transact on these networks, there are a variety of reasons why some prefer using services provided by third-party payment service providers.

Miners are responsible for grouping unconfirmed transactions into new blocks and adding them to the general/global ledger (blockchain). They provide the requisite computer power needed to secure a blockchain by computing vast quantities of hashes to find a valid block. Each valid block added by a miner to the blockchain generates a reward for the miner and makes it more difficult for an attacker to reorganize the ledger and “double-spend” already confirmed transactions.

More detailed function descriptions are provided below.

Order book exchange platforms use a trading engine to match buy and sell orders from users.

Brokerage service exchanges allow users to acquire and/or sell cryptocurrencies at a given price.

Trading platforms (i) provide a single interface for connecting to a plurality of other exchanges, and (ii) offer leveraged trading and (iii) offer cryptocurrency derivatives.

Custodial exchanges take custody of users' cryptocurrency funds.

Registered wallet corporations provide software and/or hardware wallets.

Wallet custodians take custody of users' cryptocurrency holdings by controlling the private key(s).

Self-hosted wallets allow users to control their own private key(s) and thus do not have access to users' cryptocurrency funds.

Wallets provide currency exchange services within the wallet interface using one of the following exchange models: (a) centralized exchange/brokerage model; (b) integrated third party exchange model where a wallet provider partners with a third-party exchange; or (c) peer-to-peer (“P2P”) exchange/marketplace model where wallet provider offers a built-in P2P exchange that lets users exchange cryptocurrencies between themselves.

National currency-focused payment services use cryptocurrency primarily as a “payment rail” for fast and cost-efficient payments, which are generally denominated in national fiat currencies, e.g., business-to-business (“B2B”) payment services for businesses (often-times across borders) and traditional “money-transfer” remittance and bill payment services which, again, often involve international money transfers.

Cryptocurrency-focused payment services (i) process payments for cryptocurrency-accepting merchants, as well as other merchant related services, such as shopping cart integrations, point-of-sale terminals, etc.; and (ii) perform a variety of cryptocurrency transfer services over a general-purpose cryptocurrency platform dealing in payroll, bill payments, instant payments, etc. to other users of the same platform using cryptocurrency and/or national currencies.

Mining, which was intentionally designed to be resource-intensive and difficult, has become an increasingly competitive operation. As more computing power is continually added by miners, the difficulty of “solving the puzzle” that allows miners to earn fees plus a subsidy of newly created coins (“block rewards”)—all intended to disseminate new coins in a decentralized manner while motivating people to provide security for the system—has triggered a virtual arms race amongst miners to employ the cheapest energy sources and the most efficient equipment to keep their operations profitable. As a result, this sector has evolved from a hobby activity in the early days to a multi-billion professional industry where large amounts of capital (needed to acquire and maintain sufficient processing power) are now at stake. In addition, pool mining has been introduced to enable groups of individual miners to contribute to the generation of the block and provide security for the system. In summary, mining involves substantial complexity (which has grown, arguably, to the point of counter-productivity) aimed at perpetuating the tenets of mistrust, pseudoanonymity and unregulated decentralization integral to Satoshi Nakamoto's original design of Bitcoin's blockchain technology. This invention offers an innovative cryptographic alternative to mining, aimed at perpetuating the tenets of trust and privacy befitting of a regulated financial service, as described more in disclosure sections provided below.

Finally, it should be noted that the lines between the different cryptocurrency industry sectors are becoming increasingly blurred and a growing number of cryptocurrency companies can (or aspire to soon) be characterized as “universal” platforms given the diverse range of products and services offered to their customers.

The present disclosure extends, in a novel way, the teachings of the systems and methods of the previously referenced issued patent and pending patent applications in a manner that can contribute to the transformation of a relatively nascent field's use and exchange of digital Bitcoins and altcoins employing cryptographic systems. Currently there are no known systems whereby Bitcoins and altcoins are substantively backed by diverse baskets of tradable assets intended to maintain stable long-term stores of value for users. More specifically, they have elected not to be backed by any of the many trillions of dollars of tangible assets held around the world that are relatively fungible albeit impacted by varying qualitative and logistics differences that may increase or decrease intrinsic market values in the normal course—including but not limited to (i) physically tradable commodities typically inventoried/stored while awaiting release for future use or (ii) credit instruments that are not nearly as liquid as many investors would prefer. In each case, the markets for those assets can benefit considerably by this invention's system and method of moving (or cycling interchangeably in cases where varying-yet-fungible specimens are involved) such real world assets into and out of customized permissioned ledgers (“CPL”) generated and maintained over a centralized ECN where they become integral elements of securitized DABMoE supported by underlying asset records that are digitally traceable, transactions that are digitally registered, and ownership that is digitally verifiable, thereby enabling users to receive, as compared to cryptocurrencies, more diversified and risk balanced units and tokens backed by baskets of tradable assets that can be used transactionally in lieu of cash in the sole form of national currencies.

Heretofore, many real-world assets have generally been difficult to physically transfer, subdivide and trade; so buyers and sellers instead opted to employ financially-settled index-based derivatives that are mere proxies for real assets. Index based derivatives are not nearly as substantial from a commercial standpoint, and are thus inappropriate for use as assets underlying DABMoE. This invention helps overcome attendant problems and challenges via uniform Exchange-based systems and methods needed to achieve the level of security, speed and ease of transfer suitable to securitize and tokenize DABMoE for wholesale customers of the Exchange and Exchange Affiliates, and retail user-customers of the Exchange's authorized ECCEO.

In addition, the investment field at large can benefit by this invention since it will help unlock the value of illiquid or under-utilized assets while in the process creating weighted average DABMoE Basket unitary ownership interests 18 and tandem weighted average cryptocurrency tokens 20. The units and tokens can be bought, sold and traded in fractional shares in secondary markets securely administered by a central DABMoE Exchange platform that's able to increase liquidity while minimizing transaction costs as a result of synergy established with Exchange Affiliates already designed specifically to serve customers interested in physical asset-based ownership and related trading and hedging activities.

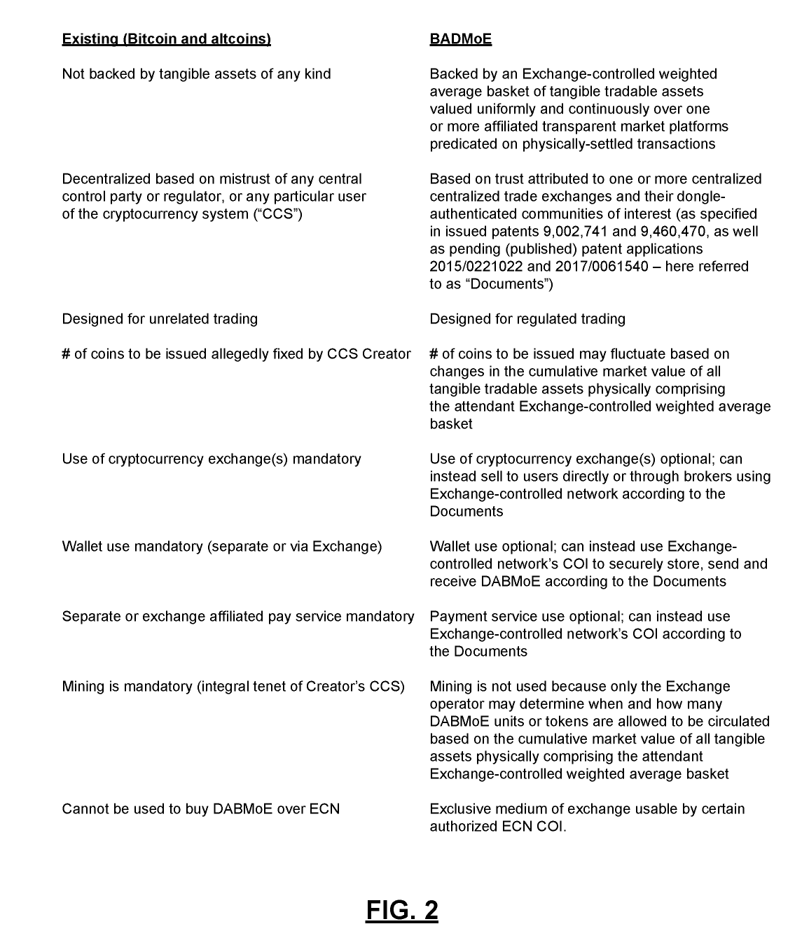

For more details, a comparative table is presented in FIG. 2 contrasting difference between Bitcoins/Altcoins and a DABMoE.

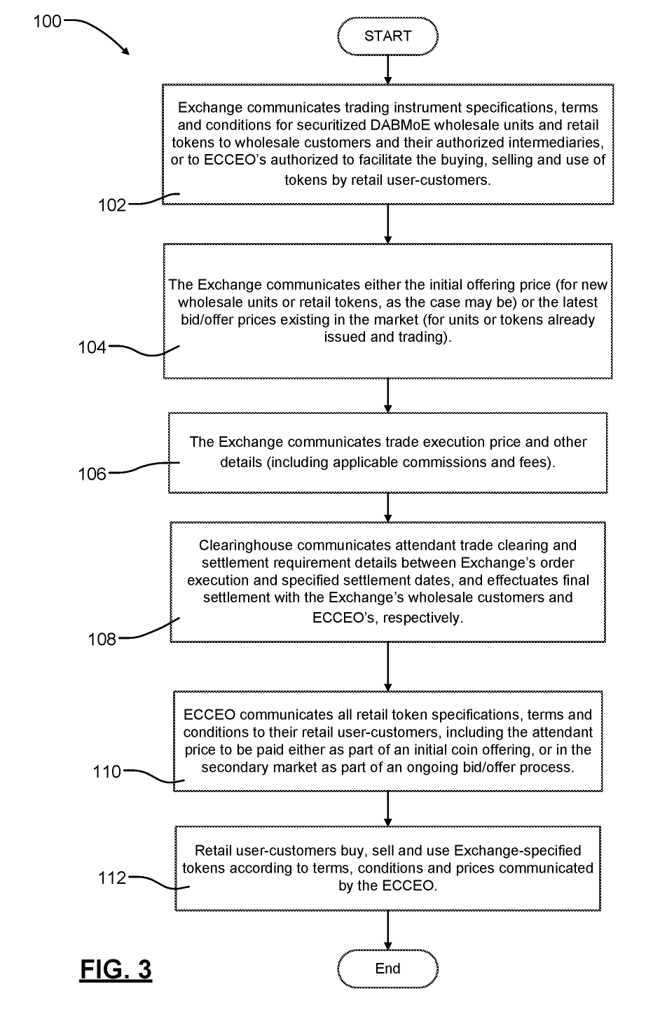

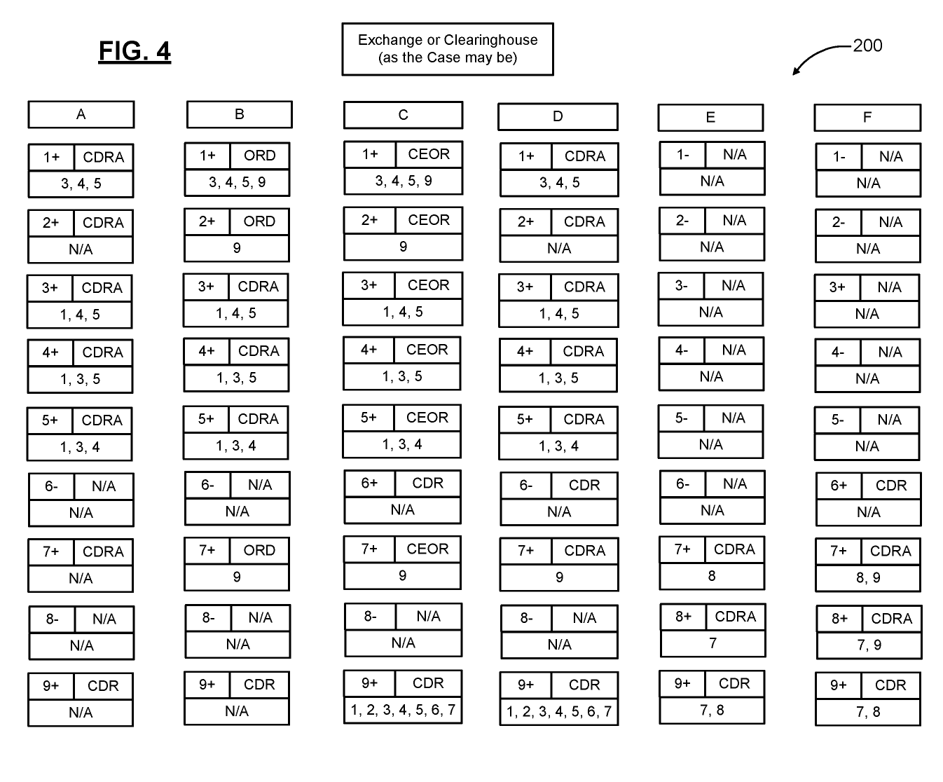

Referring further to FIGS. 1 and 3, various operations will now be described to better explain how the ECN system 10 operates. FIG. 3 illustrates a flowchart 100 setting forth various operations that the ECN system 10 may perform. The ECN system 10 communicates trading instrument specifications, terms and conditions for securitized DABMoE wholesale units and retail tokens to wholesale customers of the Exchange, Exchange Affiliates and their authorized intermediaries, or to ECCEO's authorized to facilitate the buying, selling and use of tokens by retail user-customers, as the case may be, as indicated at operation 102 (FIG. 3). Following a validating reply from authorized recipients (at operation 102), the Exchange communicates either the initial offering price (for new wholesale units or retail tokens) or the latest bid/offer prices prevailing in the market (for units or tokens already issued and trading), as the case may be, per indicated operation 104.

Following its receipt of a validating reply from authorized ordering parties, and its attendant order matching and execution at operation 104, the Exchange communicates trade execution price and other details (including applicable commissions and fees), as indicated at operation 106.

A Clearinghouse (not explicitly shown in FIG. 1 but implied as being interoperable with the Exchange) communicates attendant trade clearing and settlement requirement details between Exchange's order execution (per operation 106) and specified settlement dates, and effectuates final settlement with the Exchange's wholesale customers and ECCEO's, respectively, as indicated at operation 108. ECCEO then communicates all retail token specifications, terms and conditions to their retail user-customers, including the attendant price to be paid either as part of an initial coin offering, or in the secondary market as part of an ongoing bid/offer process, as indicated at operation 110. Retail user-customers may buy, sell and use Exchange-specified tokens according to terms, conditions and prices communicated by the ECCEO (per operation 110), as indicated at operation 112.

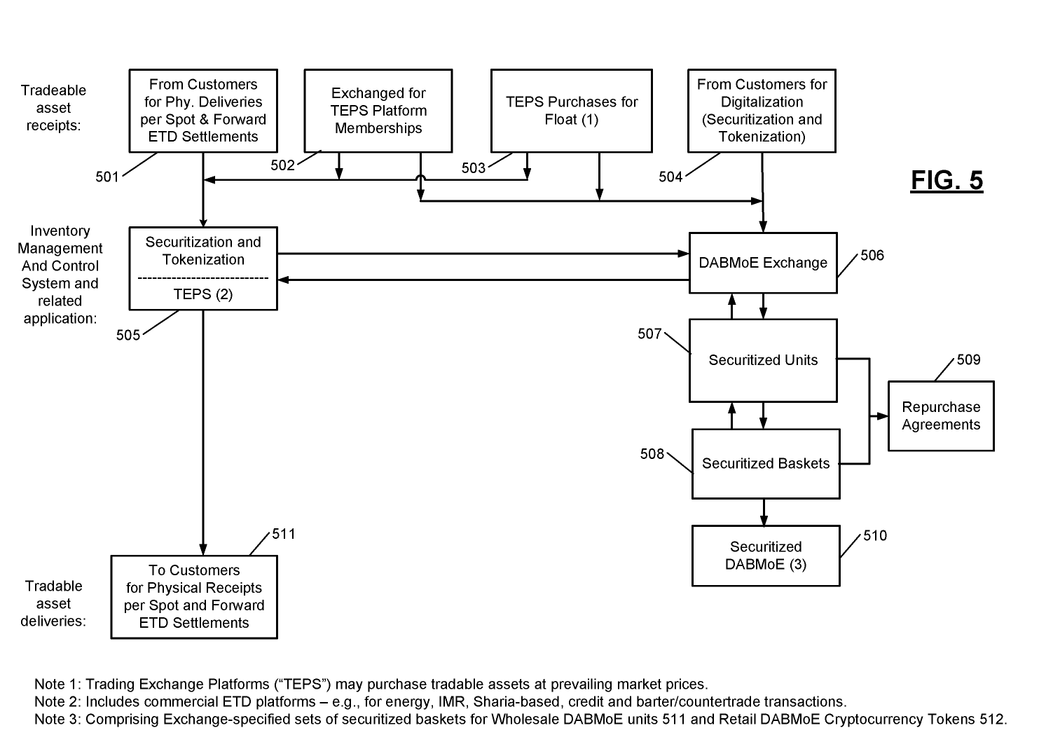

Referring to FIG. 4, a Chart Legend 200 is presented to illustrate one example of how each COI member's Exchange authentication ID number and type of Exchange and/or Clearinghouse data communications type can be assigned:

1) Exchange “wholesale” customer authorized to buy, use and sell weighted average DABMoE basket units of ownership, as well as underlying tradable assets physically settled as part of derivatives contracts executed over the Exchange.

2) Non-clearing member of the Exchange also authorized to buy, sell and use the forgoing.

3) Introducing broker (if applicable)

4) Non-clearing commercial merchant (if applicable)

5) Clearing member of the Exchange (if applicable)

6) DABMoE inventory control and serialization service providers.

7) External cryptocurrency exchange organization authorized by the Exchange.

8) “Retail” customers of an ECCEO authorized to buy, sell and use weighted average DABMoE basket cryptocurrency tokens.

9) Trade reporting service provider.

10) Although not specifically shown in FIG. 4, in light of the fact that many of the aforementioned entities may be regulated by one or more independent governmental regulatory bodies, provisions can be made for such bodies to be authenticated as COI member(s) that are granted access to certain information instrumental to the performance of their oversight responsibilities.

Within each COI member box, there may be three (3) chambers:

1) a First chamber which denotes applicable COI member's authentication ID number and whether it's authorized to access the Exchange's and/or Clearinghouse's outgoing data communications, with “+” indicating that such data is accessible and “−” indicating that it's not and therefore cloaked;

2) a Second chamber which denotes the type of reply communicated by applicable COI member to the Exchange and/or Clearinghouse—with “CDR” merely denoting confirmation of data received; “CDRA” denoting confirmation of the data being received plus acceptance as to applicable terms; “ORD” denoting confirmation, acceptance and order (bid/offer) placed by the applicable COI member to the Exchange; “CEOR” denoting confirmation of Exchange-executed order being received; and “N/A” denoting not applicable; and

3) a Third chamber which denotes which other COI members are authorized to access the forgoing (second chamber) data communicated by the replying COI member to the Exchange and/or Clearinghouse, with such other COI members shown by their respective Exchange authentication ID number.

In lieu of mining employed by the plethora of decentralized cryptocurrencies currently in the field, this invention employs a proprietary multi-faceted cryptographic serialization coding scheme designed to securely and privately establish, maintain and memorialize the dynamic progression of Exchange-authenticated origination, issuance, custody and transaction history attendant to each DABMoE unit and token. A cryptographic serialization coding scheme may be broken into segments reflective of essential digital data communications incidents cryptographically effectuated by authenticated COI members over the ECN to accomplish the forgoing activities, such as what's illustrated at FIGS. 3 and 4 and more generally presented in FIG. 5.

Segments contained in a DABMoE serialization coding scheme may reflect the following incidents (in no particular order): (i) the date and/or time when the unit's and/or token's underlying weighted average tradable asset basket is formulated for Exchange-authorized securitization and/or tokenization, a process which involves the assignment of a consecutively increasing range of baseline identification numbers (“IDN”), with a different range of IDN assigned for wholesale units and retail tokens, respectively; (ii) the date and/or time when the Exchange communicates trading instrument specifications, terms and conditions (including the original offering price or the latest bid and offer prices prevailing in the market, as applicable under the circumstances) for units targeting wholesale customers and their authorized intermediaries, and/or for tokens targeting authorized ECCEO's for further buying, selling and use by retail user-customers; (iii) the date and/or time, and applicable price per unit, when a wholesale customer order (buy or sell) is executed; (iv) the date and/or time, and applicable price per token, when an ECCEO accepts the Exchange's originating offering for a range of tokens to be resold by the ECCEO to its retail user-customers; and (v) the date and/or time, plus applicable price per token, when an ECCEO executes a retail user-customer's order to buy, sell or otherwise transfer one or more retail DABMoE tokens falling inside the IDN range accepted by the ECCEO.

It should be noted that each DABMoE Exchange-authorized ECCEO is subsequently responsible for tracking whereabouts of each and all retail tokens it accepts from the Exchange, plus insuring that each and all such tokens keep valid cryptographic codes embedded as part of the DABMoE Exchange's serialization scheme so that retail tokens can be tracked for regulatory purposes and the authenticity of tokens can be traced back to, and if necessary verified by, the DABMoE Exchange. Otherwise, the ECCEO and its retail user-customer may suffer the adverse effects of any code alterations that preclude the ability to properly trace and track authentic DABMoE retail tokens.

It should further be noted that the Exchange has flexibility under the cryptographic serialization coding scheme outlined above to authorize its ECCEO's to re-sell Exchange-issued retail DABMoE cryptocurrency tokens to their user-customers without forcing said customers to become authenticated members of the ECN, subject to the following caveats that, if not followed, would serve to invalidate the token(s): (i) unauthenticated user-customers and cryptocurrency exchanges they may subsequently trade with must not hack into or otherwise alter the assigned IDN, cloaking systems and methods or other cryptographic codes attendant to the Exchange's serialization scheme; (ii) no attendant mining or other similar validation activities typically used in connection with other cryptocurrencies, will be authorized by the Exchange and, as such, they will preclude the issuance of any valid new retail DABMoE cryptocurrency token(s); (iii) tracing and tracking histories subsequent to the initial issuance of the attendant token(s) will be the responsibilities of unauthenticated user-customers and cryptocurrency exchanges; and (iv) any Exchange-authorized future redemption of retail DABMoE cryptocurrency tokens in valid circulation held by unauthenticated user-customers or cryptocurrency exchanges must be effectuated by an Exchange-authenticated ECCEO.

As noted earlier, augmenting FIGS. 1 through 4, FIG. 5 is a flowchart presenting an overview of qualifying tradable assets specified within the confines of TEPS' various physically settleable ETD platforms and DABMoE Exchange.

Presently, there is no ability for any substantial-sized cryptocurrency (or other comparable medium of exchange) to be underpinned by physical assets aside from (i) those whose forms are virtually identical (specification-wise) due to manufacturing or other processing (e.g., precious metals) or (ii) certain bonds issued in massive quantities (e.g., U.S. Treasuries or Eurodollars all having the same credit quality). Most physical assets in the world (especially raw material stage commodities and thousands of credit instruments of different type) have varying qualitative and logistical attributes (including supply chain and life cycle considerations) that may increase or decrease their intrinsic market value. Under the current trading “status quo” dominated by conventional financialized derivatives (mainly futures and options), contracts are typically closed out via cash settlement prior to contract expiration date.

Benchmark Complex Solutions (“BCS”) were initially designed in the form of uniform systems, methods and instruments that would enable large volumes of exchange-traded derivatives (i.e., spot and forward EFP) transactions to be executed and settled via physical delivery/receipt. This latest invention extends BCS to tradable asset baskets, which can be extended even further to diverse sets of tradable asset baskets that are securitized, tokenized and thus qualified to serve as the underpinning of wholesale and retail DABMoE. Because of the varying nature of these assets, allowances must be made via (a) WAB set-based, Complementary Differential Index and Forward Point Delivery Differential Index contracts and (b) cycled interchange of assets—especially those which must soon be delivered to ETD counterparties.

Accordingly, the present invention further includes a system providing a hybrid paradigm for optimizing connectivity between physical asset markets and financial sector, the hybrid paradigm comprising digitizing fungible assets possessing varying qualitative and logistics attributes, wherein digitizing includes securitizing and tokenizing, wherein each asset gains liquidity from synergy created by transparent price-discovery, repurchase agreement (“repo”) based financing, exchange-traded derivatives (“ETD”) based value hedging, and inventory management and control processes prescribed by Benchmark Complex Solutions (“BCS”) developed to match counterparties whose trading interests are practically, rather than absolutely, opposite so that larger volumes of trade orders can be more efficiently executed and settled by physical delivery and receipt over computerized trading platforms integrating an affiliated set of Exchanges, their customers and respective communities of interest via cloud-powered, cryptography-assured and dongle-enabled ECN's and permissioned ledgers.

The BCS are comprised of one or more Exchange Affiliates configuring weighted average benchmark (“WAB”) sets, with each set linked to an Exchange-specified plurality of qualifying asset forms, rather than arbitrarily denoting one single asset form as the benchmark for all forms of that asset; identifying and factoring impact of qualitative and quantitative properties unique to the asset forms serving as a basis of a neutral WAB formulated by the Exchange for the entire set; providing a uniform method of allowances for incidences where traders physically own or are seeking to own varying yet interchangeable asset forms, each qualified as a component of an Exchange-specified set, to offer or bid their specific asset form pursuant to standardized spot or forward EFP contracts calling for settlement by physical delivery or receipt of their respective underlying assets, with each contract's specifications linked to an operative WAB formulated by the Exchange to cover an entire set of qualified asset forms; and ensuring that each component in a WAB provides quantitative characteristics, plus varying qualitative and logistics properties customarily adding to or detracting from such asset's market value, net effects of which are balanced Exchange-wide by methods integral to the following:

Establishing benchmark-specific WAB sets, each formulated for incorporation into a family of standardized exchange-traded derivatives (“ETD”) contracts, the ETD contracts including spots, forwards, futures, options and spreads, specifications of which differ only by timing and type of settlement taking place; requiring EFP spot and forward traders to acquire a specific number of long or short Complementary Differential Index contracts linked to varying qualitative attributes of underlying assets respectively delivered or received, and to ensure co-delivery of such contracts as of an operative EFP physical delivery date; requiring EFP spot and forward traders to acquire a specific number of long or short Forward Point Delivery Differential Index contracts linked to a negotiated timing of underlying assets respectively delivered or received, and to ensure co-delivery of such contracts as of an operative EFP physical delivery date; and

Uniformly employing the methods to formulate, maintain and hedge future price volatility risks of wholesale and retail DABMoE on a practically equivalent basis, achieved by instilling parameters for cycled interchange of varying-yet-fungible assets qualified within Exchange-specified baskets underpinning DABMoE, said parameters serving to account for qualitative, logistical, supply chain and life cycle factors unique to assets held and securitized by Exchange(s) prior to their delivery to counterparties, as well as assets held in reserve by Exchange(s) to ensure their ongoing role as ETD liquidity provider(s), with the parameters incorporated as part of a proprietary float processes employed within the confines of an affiliated Exchange-wide inventory management and control system.

The present invention involves tradable asset flows, as indicated in FIG. 5, which presents an overview of assets moving within the confines of TEPS' variety of physically settleable ETD platforms, and DABMoE Exchange focused on digitizing (i.e., securitizing and tokenizing) assets. It also indicates the role played by this invention's inventory management and control system responsible for addressing the interplay of diverse ranges of varying-yet-fungible assets with qualitative and logistics attributes adding to or detracting from an asset's fair market value. The overview starts with tradable assets received from TEPS related sources from: customers making physical deliveries of assets underlying spot and forward ETD settlements (shown at 501); transactions whereby parties acquire memberships in TEPS ETD platforms in exchange for tendering tradable assets, rather than cash (shown at 502); and transactions whereby TEPS purchases tradable for purposes of maintaining float instrumental in performing the role of a liquidity provider to TEPS ETD platforms (shown at 503). The overview is also extended to cover tradable assets received from customers seeking liquidity via digitization (shown at 504).

Tradable assets received from sources 501, 502 and 503 are maintained, distributed and accounted for pursuant to processes comprising inventory management and control systems (shown at 505). Some of those assets can be sent to the DABMoE Exchange where they can be digitized (shown at 506); others are earmarked for deliveries to TEPS customers who have executed orders to physically receive assets that underpin spot and forward ETD settlements (shown at 511).

At 506, the DABMoE Exchange securitizes tradable assets received from 504 and 505, with such securitizations taking the form of units 507 and baskets 508, which can access liquidity via financing vehicles such as repurchase agreements 509. Alternatively, securitized asset baskets can make up the composition of the Exchange formulated DABMoE (shown at 510). As noted elsewhere herein, many tradable assets digitized over the DABMoE Exchange platform are varying-yet-fungible in nature and therefore may not be suitable for a long-term or indefinite state of securitization. As a result, allowances are made for such assets to be de-securitized so they can become eligible for physical deliveries made in connection with spot and forward ETD settlements to TEPS customers (shown at 511). In those cases, provisions are in place for the DABMoE Exchange (506) to convert baskets (508) into units (507), which can ultimately—via the Back-to-Back Execution Module within the processes belonging to 505 (addressed elsewhere herein)—be physically delivered to customers of the operative TEPS ETB platform(s) (shown at 511).

In order to maintain DABMoE 510 on a long-term or indefinite basis, it may be necessary to substitute different varying-yet-fungible and cyclable tradable asset forms within respective net tradable asset set parameters specified by the Exchange in conformance with Benchmark Complex Solutions and likewise as part of its formulation and maintenance of a Weighted Average DABMoE Basket.

The abilities of Benchmark Complex Solutions' inventive systems, methods and instruments to facilitate physical deliveries on a substantial global scale can render futures contracts linked arbitrarily to a single asset form unnecessary, which can be a significant advance over conventional trading systems, methods and instruments that favor financial and speculator interests over those of their commercial counterparts. Incorporating Benchmark Complex Solutions within the system forming a hybrid paradigm for digitizing benchmark-qualified assets comprising DABMoE, and further enabling those underlying assets' price volatility risks to be hedgeable directly on an asset-by-asset basis via attendant ETD, thus maintaining DABMoE stores of value, represents additional inventiveness that can uniquely serve to optimize connectivity between physical asset markets and the financial sector.

While various embodiments have been described, those skilled in the art will recognize modifications or variations which might be made without departing from the present disclosure. The examples illustrate the various embodiments and are not intended to limit the present disclosure. Therefore, the detailed description and claims should be interpreted liberally with only such limitation as is necessary in view of the pertinent prior art.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses, systems and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

What is claimed is:

1. A cryptographically-assured exchange-controlled network (“ECN”) configured to formulate, securitize and issue, and to facilitate and validate buying and selling of, digitized asset-backed mediums of exchange (“DABMoE”) designed to minimize or eliminate use of established national currencies in connection with commercial and financial transactions while unlocking value of underlying tradable assets that may otherwise be illiquid or under-utilized, the ECN controlled by an Exchange organization that matches its counterparties' practically, rather than absolute, opposite trading interests predicated on physical delivery and receipt of a diverse range of commodities, credit instruments and other tradable assets having varying quality and logistics properties falling within parameters specified in physically settleable derivatives contracts formulated, traded, executed and settled over one or more Exchange Affiliates' computerized trading platforms, wherein tradable assets qualifying as part of benchmark sets are physically segregated and securitized into unitary ownership interests encompassing one or more Exchange-formulated weighted average DABMoE Baskets, the ECN comprising:
at least one processor configured to execute a plurality of machine executable instructions;
at least one memory in communication with the processor, the memory configured to store the machine executable instructions which when executed by the processor are configured to:
collect data for a plurality of underlying tradable assets that are acquired, segregated, inventoried and controlled by the Exchange on behalf of owners of DABMoE Basket unitary interests, wherein the data include at least one parameter relating to a physical property or quality of the tradable assets;
select assets from the tradable assets based on either the at least one parameter, or physical property or quality, of the assets, to generate sets of tradable assets underlying attendant weighted-average DABMoE Basket unitary ownership interests;
generate weights for generating weighted averages, wherein a weight for generating a weighted average for sets of underlying tradable assets contained in a weighted-average DABMoE Basket is based on at least an Exchange-specified rate denoting estimated global commercial significance of a selected tradable asset relative to aggregate estimated global commercial significance of all tradable assets underlying attendant weighted-average DABMoE Basket unitary interests formulated by the Exchange for customer ownership, use and trading;
generate tradable asset baskets based on aggregate weighted averages of properties of the selected tradable assets in a basket;
communicate weighted average DABMoE Basket of tradable assets, and related unitary interests formulated by the Exchange for their ownership and trading, to customers and receive orders for such unitary interests from authenticated traders of the Exchange and other parties entitled to buy or sell such unitary interests; and
operate with the data collection, selection, weight generating, basket generating, communication and order processing modules as a DABMoE conversion module (“DCM”) that subdivides the weighted-average DABMoE Basket into Exchange-authorized quantities of: unitary ownership interests formulated for offerings to wholesale user-customers of the Exchange; and cryptocurrency tokens formulated for offerings to external cryptocurrency exchange organizations (“ECCEO”) that register and service retail user-customers who want to buy, hold and sell said cryptocurrency tokens, while also providing said customers with wallet and payment facilitation applications unique to centralized networks that prevent incidences of fraud, such as manipulated or falsified transactions, as well as double-spending and reversals; and
wherein orders of weighted-average DABMoE Basket unitary ownership interests offered to wholesale user-customers of the Exchange, plus orders of weighted-average DABMoE Basket-based cryptocurrency tokens offered to ECCEO, are effectuated by a back-to-back execution module that is processed by an application stored in the memory and executed by the processor, the application employed to take into consideration the gross segregated tradable asset inventories on hand for each type of asset, a portion of such inventories to be held in reserve to optimize an efficiency of the Exchange organization in matching its counterparties' physically settled derivatives orders over a projected future time frame, and an ability to substitute different varying-yet-fungible and cyclable tradable asset forms within respective net tradable asset set parameters specified by the Exchange as part of its formulation and maintenance of a weighted average DABMoE Basket.

2. The ECN of claim 1, wherein the tradable assets comprise at least one of the following types:
energy commodities in a form of crude oil, refined products derived from crude oil, natural gas and coal;
industrial minerals and rocks (IMRs), and fertilizers derived therefrom;
any other commodity produced globally and having varying quality and logistics properties or attributes that impact a market place value of the asset;
any credit or other financial instrument having varying quality and logistics properties or attributes that impact a market place value of the instrument;
any national currency; and
any other tradable asset that is exchangeable according to terms of a barter or countertrade transaction executable over an Exchange Affiliate's barter or countertrade platform.

3. The ECN of claim 1, wherein the tradable assets segregated, inventoried and controlled by the Exchange are acquired from Exchange members including but not limited to asset producers, trading companies, financial institutions and investors, with such acquisitions transacted either via cash payments made by the Exchange, issuance of one or more Exchange memberships or issuance of weighted-average DABMoE Basket unitary ownership interests.

4. The ECN of claim 1, wherein:
the collected data is updated periodically;
the weighted-average DABMoE Basket is updated based on the collected updated data; and
the weighted-average DABMoE Basket is communicated to the ECN's defined communities of interest (“COI”).

5. The ECN of claim 1, wherein the ECN comprises a server in communication with a computing device used by the ECN's defined COI via at least one of a wide area network or the Internet.

6. The ECN of claim 1, wherein the weighted-average DABMoE Basket unitary ownership interest registrants, the ECCEO and its registrants are provided customized hardware and/or software dongles for their respective servers, with each having a unique authorization code serving to:
control access to the ECN, what data is made available to each host and front-end server connected over the ECN, where data is stored and who manages various storage needs within the ECN's defined COI;
enable buy and sell orders of weighted-average DABMoE unitary ownership interests and ECCEO cryptocurrency tokens to be cryptographically authenticated, posted, and ultimately matched, executed and cleared as valid trades to be settled and reported over the ECN in accordance with policies and rules established by the Exchange; and
accomplish the controlling and the enabling, contemporaneously, without the need for intermediaries to be used in the chain of communications, all the while facilitating creation and maintenance of customized permissioned ledgers shared by impacted COI in the process.

7. The ECN of claim 1, wherein the back-to-back execution module is operative with the DCM to consolidate all customer bids and offers for ultimate execution at the Exchange pursuant to a cross-liquidity process factoring prevailing relative order flow of each Exchange trading platform and each ECCEO, and triggers, when necessary, back-to-back executions such that:
the Exchange becomes a counterparty to its primary customer's weighted-average DABMoE Basket unitary ownership interest bid or offer; and
the Exchange then simultaneously posts an offsetting offer or bid, which upon DCM processing is converted to a component of either a weighted-average DABMoE Basket unitary ownership interest or cryptocurrency token earmarked for retail syndication via one or more ECCEO.

8. The ECN of claim 7, wherein the processor uses the application to compute requisite number of weighted-average DABMoE Basket unitary ownership interests and cryptocurrency tokens, respectively, authorized for issuance by the Exchange and operates in cooperation with a Serialization Module to assign Exchange-authorized serial numbers to each unit and token, respectively and without any rights of interchangeability, as well as to any applicable sub-serial numbers attendant to fractional interests connected thereto.

9. The ECN of claim 8, wherein each Serialization Module-assigned serial number and sub-serial number digitally reflects cryptographic histories of all key functions having occurred over the ECN in connection with attendant inventory control and DABMoE formation, securitization, issuance and originating valuation processes, all incorporated into a Digital Identification Scheme enabling the Exchange to confirm validity, via unique encrypted origination and history data, of all weighted-average DABMoE Basket unitary ownership interests and cryptocurrency tokens placed into and removed from circulation since inception to guard against threats of manipulated or falsified transactions perpetrated in the field and, when combined with attendant cryptographic signature or key creates an immutable and traceable ledger entry accessible by authorized COI over the ECN.

10. The ECN of claim 7, wherein the Exchange is the only entity authorized to issue weighted-average DABMoE Basket unitary ownership interests and crypto-currency tokens, respectively, and to assign their attendant serial numbers and sub-serial numbers, and does not recognize interchangeability or ownership claims of any units, tokens, serial numbers or sub-serial numbers alleged to have been created by unauthorized token miners or other parties practicing similar computer processes common to decentralized cryptocurrency schemes such as Bitcoin or other alternative cryptocurrencies in the field.

11. The ECN of claim 3, wherein the Exchange employs inventory management and control systems attendant to the computation of qualifying gross and net segregated tradable assets available for securitization and tokenization, with such systems employing at least private and public warehouse receipts and shipping certificates that can be reconciled with all issued and outstanding weighted-average DABMoE Basket unitary ownership interests and cryptocurrency tokens in the field.

12. The ECN of claim 8, wherein the Exchange employs inventory management and control systems attendant to the computation of qualifying gross and net segregated tradable assets available for securitization and tokenization, with such systems employing at least private and public warehouse receipts and shipping certificates that can be reconciled with all issued and outstanding weighted-average DABMoE Basket unitary ownership interests and cryptocurrency tokens in the field.

13. The ECN of claim 1, wherein the Exchange-authorized COI includes at least one of:
ECCEO that register and service retail user-customers for token trading while also providing those customers with Exchange-authorized wallet and payment facilitation applications;
wholesale commercial and speculator customers of the Exchange;
introducing brokers;
non-clearing commercial merchants;
clearing members of the Exchange or its Exchange Affiliates;
non-clearing members of the Exchange or its Exchange Affiliates;
one or more Exchange-authorized tradable asset inventory control and logistics service providers;
one or more Exchange-authorized tradable asset securitization service providers;
one or more clearinghouses either affiliated with the Exchange or independently contracted;
one or more trade reporting service firms; and
one or more independent regulatory bodies charged with oversight responsibility in connection with the conduct of the Exchange's trading markets.

14. The ECN of claim 1, wherein a hybrid paradigm is formed to digitize benchmark-qualified assets, the digitizing including securitizing and tokenizing, that are varying-yet fungible and thus cyclable in and out of baskets comprising the benchmark-qualified assets, all transparently price-discoverable, financeable and hedgeable via an integrated suite of affiliated computerized trading exchange platforms globally organized around a common cloud-based exchange-controlled network.

15. The ECN of claim 1, wherein the Exchange authorizes the ECCEO's to resell Exchange-issued retail DABMoE cryptocurrency tokens to user-customers without forcing said customers to become authenticated members of the ECN, subject to the following caveats that, if not followed, serve to invalidate the tokens:
unauthenticated user-customers and cryptocurrency exchanges they subsequently trade with do not alter assigned identification numbers (“IDN”), cloaking systems and methods, and other cryptographic codes attendant to a serialization scheme of the Exchange;
no mining or other similar validation activities typically performed in connection with other cryptocurrencies are authorized by the Exchange and, as such, preclude the issuance of any valid newly-issued retail DABMoE cryptocurrency token(s);
all tracking and tracing histories subsequent to initial issuance of the attendant token(s) by the Exchange are responsibilities of the unauthenticated user-customers and cryptocurrency exchanges; and
any future Exchange-authorized redemption of retail DABMoE Cryptocurrency tokens in valid circulation held by unauthenticated user-customers or cryptocurrency exchanges is effectuated by an Exchange-authenticated ECCEO.

16. A system providing a hybrid paradigm for optimizing connectivity between physical asset markets and financial sector, the hybrid paradigm comprising digitizing fungible assets possessing varying qualitative and logistics attributes, wherein digitizing includes securitizing and tokenizing, wherein each asset gains liquidity from synergy created by transparent price-discovery, repurchase agreement (“repo”) based financing, exchange-traded derivatives (“ETD”) based value hedging, and inventory management and control processes prescribed by Benchmark Complex Solutions (“BCS”) developed to match counterparties whose trading interests are practically, rather than absolutely, opposite so that larger volumes of trade orders are more efficiently executed and settled by physical delivery and receipt over computerized trading platforms integrating an affiliated set of Exchanges, their customers and respective communities of interest via cloud-powered, cryptography-assured and dongle-enabled ECN's and permissioned ledgers.

17. The system of claim 16, wherein the BCS are comprised of one or more Exchange Affiliates:
configuring weighted average benchmark (“WAB”) sets, with each set linked to an Exchange-specified plurality of qualifying asset forms, rather than arbitrarily denoting one single asset form as the benchmark for all forms of that asset;
identifying and factoring impact of qualitative and quantitative properties unique to the asset forms serving as a basis of a neutral WAB formulated by the Exchange for an entirety of the set;
providing a uniform method of allowances for incidences where traders physically own or are seeking to own varying yet interchangeable asset forms, each qualified as a component of an Exchange-specified set, to offer or bid their specific asset form pursuant to standardized spot or forward EFP contracts calling for settlement by physical delivery or receipt of their respective underlying assets, with each contract's specifications linked to an operative WAB formulated by the Exchange to cover an entire set of qualified asset forms; and
ensuring that each component in a WAB provides quantitative characteristics, plus varying qualitative and logistics properties customarily adding to or detracting from such asset's market value, net effects of which are balanced Exchange-wide by methods integral to:
establishing benchmark-specific WAB sets, each formulated for incorporation into a family of standardized exchange-traded derivatives (“ETD”) contracts, the ETD contracts including spots, forwards, futures, options and spreads, specifications of which differ only by timing and type of settlement taking place;
requiring EFP spot and forward traders to acquire a specific number of long or short Complementary Differential Index contracts linked to varying qualitative attributes of underlying assets respectively delivered or received, and to ensure co-delivery of such contracts as of an operative EFP physical delivery date;
requiring EFP spot and forward traders to acquire a specific number of long or short Forward Point Delivery Differential Index contracts linked to a negotiated timing of underlying assets respectively delivered or received, and to ensure co-delivery of such contracts as of an operative EFP physical delivery date; and
uniformly employing the methods to formulate, maintain and hedge future price volatility risks of wholesale and retail DABMoE on a practically equivalent basis, achieved by instilling parameters for cycled interchange of varying-yet-fungible assets qualified within Exchange-specified baskets underpinning DABMoE, said parameters serving to account for qualitative, logistical, supply chain and life cycle factors unique to assets held and securitized by Exchange(s) prior to their delivery to counterparties, as well as assets held in reserve by Exchange(s) to ensure their ongoing role as ETD liquidity provider(s), with the parameters incorporated as part of proprietary float processes employed within the confines of an affiliated Exchange-wide inventory management and control system.
